(19) United States
(12) Patent Application Publication
(10) Pub. No.: US 2007/0136406 A1
(43) Pub. Date: Jun. 14, 2007

(54) Method and system for numerical computation visualization

(76) Inventor: William R. Softky, Menlo Park, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/605,820

(22) Filed: Nov. 27, 2006

Related U.S. Application Data
(60) Provisional application No. 60/749,986, filed on Dec. 12, 2005.
(60) Provisional application No. 60/759,662, filed on Jan. 17, 2006.

(51) Int. Cl. G06F 15/00

(52) U.S. Cl. 708/200

(57) ABSTRACT

A tool allows a user to visualize numerical computations (as opposed to visualizing only data). The tool inputs and reads in data and computations in an information source (e.g., a spreadsheet file) and then parses the read data. The extracted information is then used to build a software object, which is acted upon by display operations to visualize at least one computation represented by at least a portion of the extracted information in the software object. The displayed computation has a node and an input line having visually distinguishing characteristics to allow for ease of visualizing numerical computations in the information source.

### CROSS-REFERENCE TO RELATED APPLICATIONS

The present application claims priority, under 35 U.S.C. § 119, of U.S. Provisional Patent Application No. 60/749,986, filed on Dec. 12, 2005 and entitled “Flowsheet Visualization Tool”, and U.S. Provisional Patent Application No. 60/759,662, filed on Jan. 17, 2006 and entitled “Flowsheet Visualization Tool”.

### BACKGROUND

Business, technology, and science are dependent upon people understanding and analyzing numbers. Some might suggest that no single set of innovations has more revolutionized numerical analysis than the creation, over a century ago, of the graphical display of data (e.g., line graphs, scatter plots, bar charts) and the more recent automation of such processes by computers. People, in any of an innumerable amount of settings, frequently interact with numbers by primarily viewing graphs produced by a computer.

One particular set of tools that has facilitated interaction with numbers involves spreadsheet software computer applications (generally “spreadsheets”). As well known, spreadsheets are computer programs that allow users to organize data in a tabular format, typically in cells arranged in rows and columns. Various different types of spreadsheets are available today (e.g., Excel® by Microsoft Corporation, Lotus 1-2-3® by IBM Corporation), including many that are or can be specialized or customized for particular purposes related to, for example, invoicing, databases, project management, and corporate finance management.

Generally, using a spreadsheet involves entering or changing values in particular cells of the spreadsheet and then performing spreadsheet computations (or “calculations” or “operations”) such as, for example, addition, subtraction, multiplication, division, and averaging. The outputs of these computations are then displayed and/or used as inputs for other computations. Moreover, computations can be performed based on particular formulas referenced by one or more cells of the spreadsheet.

An example of a representative use (an Internet ad campaign) of a typical spreadsheet is provided below:

| | A | B | C | D | E | F | G | H |
|---|---|---|---|---|---|---|---|---|
| 1 | cost | ad | Click | Revenue | sale | Cost | total revenue | Profit |
| | per | count | ratio | per sale | ratio | | | |
| | click | | | | | | | |
| 2 | $1.00 | 1000 | 0.012 | $30.00 | 0.05 | A2*B2*C2 | B2*C2*D2*E2 | G2−F2 |

Cost is computed by multiplying the values in cells A2, B2, and C2. Total revenue is computed by multiplying the values in cells B2, C2, D2, and E2. Profit is then computed by subtracting the value computed in F2 from the value computed in G2. Thus, in general, spreadsheets are used both to calculate and to visualize data, where the data is manually entered or is the result of computations on other data.

The development of interactions with data, including those associated with the use of spreadsheets, has so far only applied to the graphing of numerical data—or collection of numbers—but not yet to the graphing of the computations and equations that may produce such numbers. When people ordinarily try to understand equations, they must read a set of symbols (e.g., “10−3=7”) and picture “in their minds” the processes involved. There is not yet a standard visual language of shape and color for showing, for example, that the number 7 results from the subtraction of 3 from 10, nor is there an automated system for taking the digitized numbers and equations together and creating such a viewable image.

Still referring to the spreadsheet example shown above, to understand how profit is computed, a user has to look at cells F2 and G2, look up the formulas in those cells in terms of cells A2, B2, C2, D2, and E2, and mentally translate each of those terms into its own category by looking at the heading in the top row. To understand how profit is affected, the user has to find each symbol's position in the profit computation, its value in its own cell, and the effect it has on the result of the profit computation as a whole. Those skilled in the art will note that such understanding requires careful mental effort and becomes more difficult as the complexity of the spreadsheet increases. Moreover, the difficulty of performing mental notations and computations not only impacts the user's performance and efficiency, but can result in errors in the formulas they use and can make discovering errors in the formulas difficult.

### SUMMARY

According to at least one aspect of one or more embodiments of the present invention, a computer-implemented method of visualizing numerical computations includes inputting an information source specifying numbers and computations using the numbers. The method also includes extracting information from the inputted information source. The method further includes constructing a software object with representations of computations associated with the extracted information. The method additionally includes displaying at least one of the computations, wherein the at least one displayed computation includes a node having at least one input line.

According to at least one other aspect of one or more embodiments of the present invention, a system for visualizing spreadsheet computations includes a first module arranged to input data from an information source. The system also includes a second module arranged to parse the inputted data. The system further includes a third module arranged to construct a software object with information extracted by the second module. The system additionally includes a fourth module arranged to display at least one computation represented by at least a portion of the extracted information in the software object, where the at least one displayed computation includes a node representing a computation using a value represented by at least one input line to the node.

According to at least one other aspect of one or more embodiments of the present invention, a computer-readable medium has instructions stored therein that are executable by a processor to: read in an information source; extract information from the read information source; construct a software object with representations of computations associated with the extracted information; and display at least one of the computations, wherein the at least one displayed computation includes a node having at least one input line.

The features and advantages described herein are not all inclusive, and, in particular, many additional features and advantages will be apparent to those skilled in the art in view of the following description. Moreover, it should be noted that the language used herein has been principally selected for readability and instructional purposes and may not have been selected to circumscribe the present invention.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 shows an example of spreadsheet computation visualization in accordance with an embodiment of the present invention.

FIG. 2 shows a numerical computation visualization tool in accordance with an embodiment of the present invention.

FIG. 3 shows an example of a tree structure in accordance with an embodiment of the present invention.

FIG. 4 shows a flow process in accordance with an embodiment of the present invention.

FIG. 5 shows an example of numerical computation visualization in accordance with an embodiment of the present invention.

FIG. 6 shows an example of numerical computation visualization in accordance with an embodiment of the present invention.

FIG. 7 shows an example of a “flattened” numerical computation visualization in accordance with an embodiment of the present invention.

FIGS. 8A, 8B, 8C, 8D, 8E, and 8F show examples of shapes representing different computational operations in accordance with an embodiment of the present invention.

FIG. 9 shows an example of numerical computation visualization in accordance with an embodiment of the present invention.

FIG. 10 shows an example of numerical computation visualization in accordance with an embodiment of the present invention.

FIG. 111 shows an example of numerical computation visualization in accordance with an embodiment of the present invention.

Each of the figures referenced above depict an embodiment of the present invention for purposes of illustration only. Those skilled in the art will readily recognize from the following description that one or more other embodiments of the structures, methods, and systems illustrated herein may be used without departing from the principles of the present invention.

### DETAILED DESCRIPTION

In the following description of embodiments of the present invention, numerous specific details are set forth in order to provide a more thorough understanding of the present invention. However, it will be apparent to one skilled in the art that the present invention may be practiced without one or more of these specific details. In other instances, well-known features have not been described in detail to avoid unnecessarily complicating the description.

Embodiments of the present invention generally relate to methods and systems for visualizing numerical computations. More particularly, in one or more embodiments, images showing numerical computations may be automatically constructed and displayed by a computer system. One or embodiments may use data and equations from any source: computer programs (e.g., in Java language developed by Sun Microsystems); scripting languages (e.g., Perl, Python); business-logic programs (e.g., Crystal Reports by BusinessObjects); data-analysis software (e.g., SAS, MATLAB), or native database languages (e.g., Structured Query Language (SQL)). Any information-processing system having equations or operations capable of creating numerical outputs may provide those equations and numbers as inputs for a visualization tool in accordance with one or more embodiments described herein. Thus, although the use of spreadsheets is described herein for purposes of clarity and illustration, any source of data and/or operations/equations/computations may be used without departing from the scope of the present invention.

Spreadsheets generally use a consistent language for describing where a number resides (e.g., in a “cell”), for locating the number (the cell's location on a grid (e.g., “B7”)), and for constructing equations of inputs from other cells (e.g., “B13=B10+B11−B12”). This computational language is typically simpler and more standardized than disparate “programming” languages, such as some of the ones described above, and thus, is used for illustrating the automated visualization methods described herein. Any algebraic computation from the other programming languages may also be expressed as a spreadsheet computation, and as such, those skilled in the art will understand that the description herein of one or more embodiments with reference to spreadsheet computations does not restrict application to other sources of computational information.

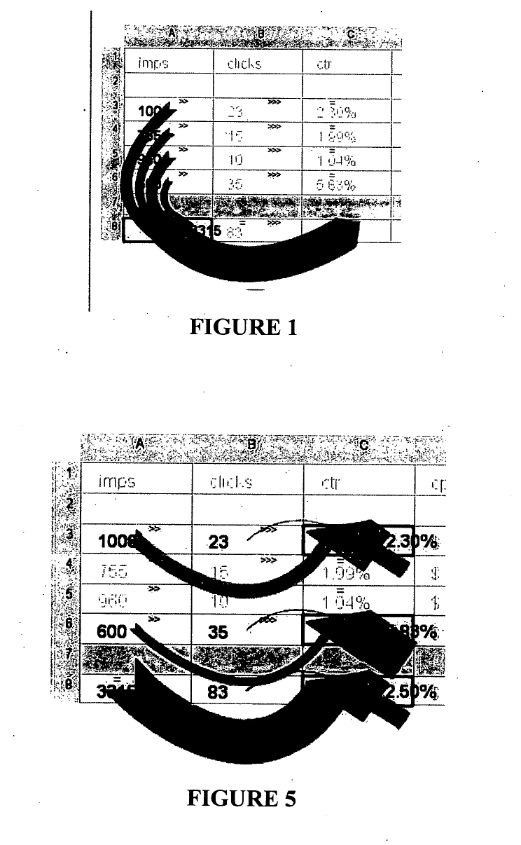

In one or more embodiments, upon selection, a graph of a spreadsheet computation or set of computations is automatically displayed. FIG. 1 shows an example of a spreadsheet computation visualization. Particularly, FIG. 1 shows a computation of the formula shown in cell A8, which is equal to A3+A4+A5+A6. Thus, as discernible from the spreadsheet computation visualization example shown in FIG. 1, as a spreadsheet computation is determined, one or more embodiments automatically discover which computations depend on the outputs of which other computations and use that information to display a graph showing how every output may be traced back to every input, even across multiple computations.

FIG. 2 shows an exemplar numerical computation visualization tool 20 in accordance with an embodiment of the present invention. The numerical computation visualization tool 20 is shown as having a plurality of modules, where a “module” is defined as any program, logic, and/or functionality implemented in hardware and/or software. The numerical computation visualization tool 20 may be part or all of any computer-readable medium (e.g., a floppy disk, a compact disc (CD), a digital video disk (DVD), read-only memory (ROM), random access memory (RAM), a flash drive, a universal serial bus (USB) drive) having instructions stored and therein that are executable by a processor. Further, there is no limitation on how the numerical computation visualization tool 20 may be implemented. For example, the numerical computation visualization tool 20 may be built into a commercial spreadsheet offering. In one or more other embodiments, the numerical computation visualization tool 20 may not be associated with a commercial spreadsheet application and instead may be used in association with, for example, a database dashboard.

The numerical computation visualization tool 20 includes a file inputter module 22. The file inputter module 22 is capable of reading in one or more types of information sources (e.g., spreadsheet files). To achieve such reading, the file inputter module 22 may use particular application program interfaces (APIs) for manipulating various file formats. For example, for reading Microsoft Excel® files, the file inputter module 22 may use Jakarta POI by the Apache Software Foundation.

Further, the numerical computation visualization tool 20 includes a parser module 24. The parser module 24 traverses the spreadsheet format file read in by the file inputter module 22 and extracts from the file information (e.g., value, label ($, %, etc.), formula) for each cell. Moreover, for cells containing formulas, the parser module 24 parses the formulas into constituent tokens. For example, parser module 24 parses formula “5+6.2” into tokens “5”, “+”, and “6.2”.

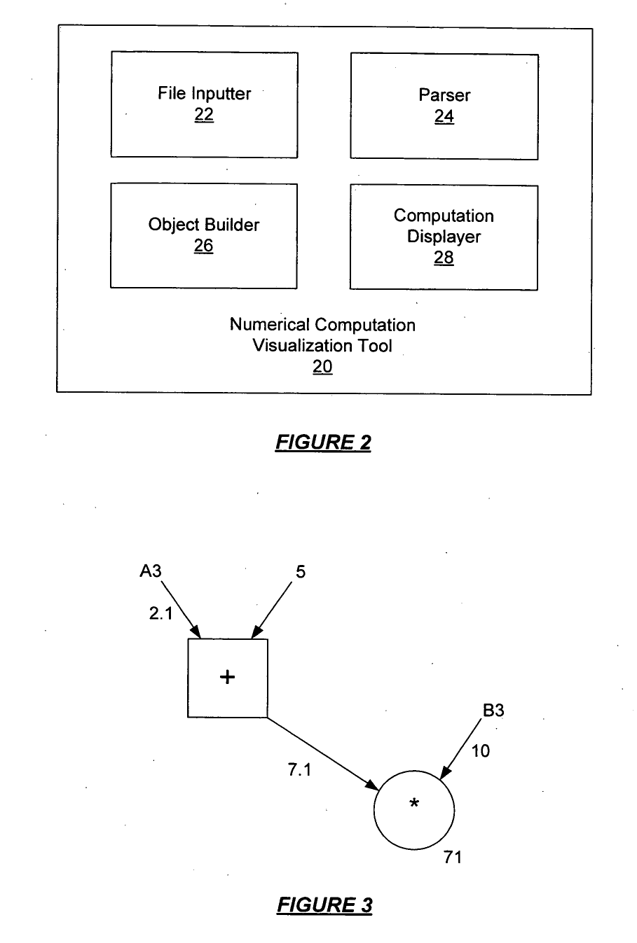

The information extracted by the parser module 24 is then used by an object builder module 26 to construct a software object containing the extracted information. In one or more embodiments, this software object is of a tree structure, where each node represents a computation, a number, or a reference to another cell, and where each edge of the tree structure represents a numerical value. For example, the computation “(5+A3)*B3” (where A3=2.1, B3=10) may be represented by the tree structure shown in FIG. 3. The output of a node is the result of its computation. The children of a node are the inputs to it. The parents of a node are any nodes whose inputs are its outputs. Thus, in the example shown in FIG. 3: the first node has inputs A3 and 5 and computes their sum; and the second node has that sum as one of its inputs, the value of cell B3 as its other input, and computes their product.

Because each node of a tree structure built by the object builder module 26 “knows” all of its inputs (e.g., the numbers inside the formula, references to other nodes' outputs, references to other cells), it is possible to trace backwards through all of that node's children, grandchildren, etc. to find the raw, original source of every number in the computation and every intermediate computation step involved in transforming the raw source into the final result.

Still referring to FIG. 2, the numerical computation visualization tool 20 further includes a computation displayer module 28. The computation displayer module 28, as further described with reference to FIGS. 1 and 5-11, takes the information structured in the software object constructed by the object builder module 26 and renders (or causes the rendering of) visualizations of the computations represented in the software object.

The numerical computation visualization tool 20 described above with reference to FIG. 2 may be made available for access and use in many ways. For example, in one or more embodiments, the numerical computation visualization tool 20 may be available as an “off-the-shelf” computer program that can be purchased and installed on a user's personal computer system (e.g., desktop, laptop, handheld computing device). In one or more other embodiments, the numerical computation visualization tool 20 may be resident on a host or server system, where access and use of the numerical computation visualization tool 20 is facilitated via a wide area network (WAN) (e.g., the Internet) or a local area network (LAN) (e.g., an enterprise network). With a WAN, for example, a user may be charged some fee to use the numerical computation visualization tool 20 hosted on a remote web server. Such a fee may be based on various factors such as, for example, number of uses, subscription level, size of input files, use of particular features, and/or length of time of use.

FIG. 4 shows a flow process in accordance with an embodiment of the present invention. Initially, in step 40, a spreadsheet format file is inputted to a numerical computation visualization tool 20. The spreadsheet format file is then parsed in step 42 to extract information about each cell in the spreadsheet, where the information includes one or more of values, labels, and formulas. The parsed, extracted information is then used in step 44 to construct a software object, which represents, at least in part, computations referenced in the spreadsheet. The computations represented in the software object built in step 44 are then visualized in step 46, as further described with reference to FIGS. 1 and 5-11.

Computation Display Selection

Those skilled in the art will note that a spreadsheet may have many cells, and many of them may have their own formulas. If computations of every cell's formula were to be displayed, this may result in a confusing and/or complex display of overlapping computations. Thus, in one or more embodiments, particular computations may be selected for display.

Initially, a digest of the spreadsheet is displayed as, for example, a grid of cell values (thus, possibly looking like the original spreadsheet). In one or more embodiments, each cell with a formula has a “=” icon, which, when clicked (using a mouse) or otherwise selected (via keyboard presses), opens that cell's computation for display. A second click or selection may reverse the process and “close” that computation's display.

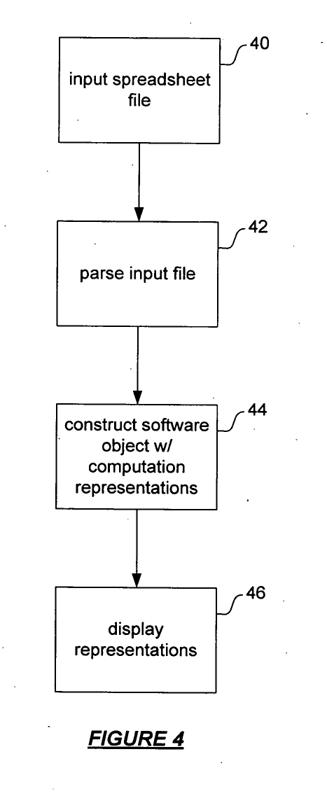

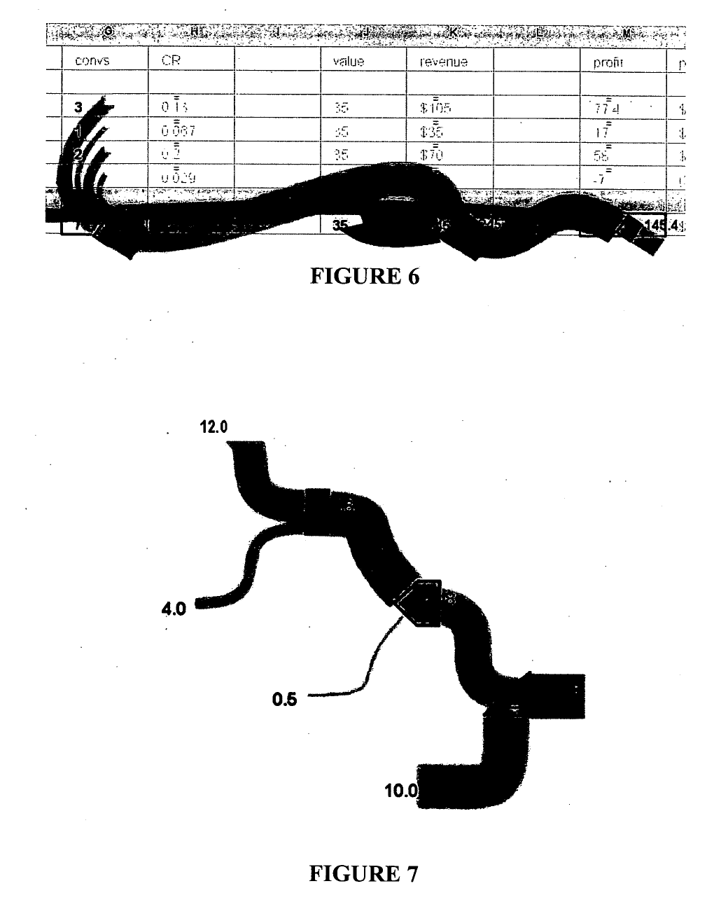

FIGS. 5 and 6 show examples of computation display selection as described above. FIG. 5 shows three division computations, illustrated by opening the icons in cells C3, C6, and C8. FIG. 6 shows a sequence of addition, multiplication, and subtraction computations, opened from cells G8, K8, and M8. The combination of the displayed computations in FIGS. 5 and 6 form the full computation visualization shown in FIG. 1. In one or more other embodiments, instead of displaying each computation node on top of the cell to which it corresponds, the computations may in addition or instead be displayed ordered from left-to-right for visual clarity, as illustrated in FIG. 7.

Each of FIGS. 1, 5, and 6 is visualizing a different computation or set of computations from the same spreadsheet, but in each case, the red rectangles represent computations which are visualized (or “opened”) independently: FIG. 1—visualizing a single computation, where cells A3-A6 are summed to produce the value in cell A8 and the result is used by a further formula in cell C8; FIG. 5—visualizing several similar computations operating on corresponding sets of numbers, where each value in Column C (shown C3, C6, and C8) is the result of dividing the value from column B by that from column A; and FIG. 6—visualizing several dissimilar computations operating in sequence, where the output of one provides input to another (the sum in cell G8 is multiplied by the value in cell J8 to produce the product in cell K8, which in turn has another value (source not shown) subtracted from it in cell M8).

Magnitude Proportionality

When displaying a computation, each node is drawn at some location (X_node, Y_node) on the display. The inputs to the node—from other nodes, other cells, or raw numbers—appear as lines or curves coming from the location (X_i, Y_i) of the corresponding input. In one or more embodiments, a pixel-width W of the input line may be determined as: W=W₀*(numerical value of input)/max-val, where W₀ is a reference width. Once a pixel-width of a line is determined, a graphics command may be invoked to draw a line or smooth curve of width W from (X_i, Y_i) to (X_node, Y_node). In one or more other embodiments, the line may be drawn from a point “near” (X_i, Y_i) to “near” (X_node, Y_node) to accommodate the size of the node shapes drawn at those two locations. Further, if a curve is drawn, then the angle at which each end of the curve approaches its node may be a separate parameter to the graphics command. Those skilled in the art will note that controlling the angle of the curve at its endpoint allows displaying curves with a minimum number of bends or with minimum curvature, or allows a visually smooth flow from the input to a node to its output.

Magnitude Rescaling

In one or more embodiments, the numerical computation visualization tool 20 may automatically rescale magnitudes (line widths), so that the magnitudes of lines sharing the same units have widths proportional to their magnitude, with the largest absolute magnitude of that unit having the largest width. Further, there may be a different scale factor for each color, so that the computation display may meaningfully show both a group of small values and a group of large values, with values within each group visible and comparable.

Once unit types are assigned, and the user has decided which nodes to display, the numerical computation visualization tool 20 may traverse the tree structure and find the maximum and minimum output values for each unit type. The numerical computation visualization tool 20 may then choose, for each unit, whichever of those two numbers (maximum or minimum) has the greatest magnitude (a large negative number has a larger magnitude than a smaller positive number); this chosen number now becomes the “max-val” scale factor described above. In one or more embodiments, upon traversing the tree structure, a line's displayed width in pixels is given by a reference with W=W₀*(numerical value of input)/max-val in pixels, as described above. Thus, the widest displayed line, whether positive or negative, has a width of W₀, and all other lines sharing that unit type have narrower widths. As a result, in one or more embodiments, line magnitudes are shown relative to the largest magnitude of an “open” line—opening or closing other lines may change the scaling, revealing or hiding detail and allowing a wide range of comparisons.

Color and Texture Differentiation

As described above, values in a spreadsheet have different meanings. For example, one set of numbers may represent the dollar value of a widget, another set of numbers may represent the dollar value of all widgets together, another set of numbers may represent the number of widgets sold on a particular day, and another set of numbers may represent the fraction of widgets sold on a particular day. In this example, there are three units of numbers: widget count; %, and $. A displayed computation node may carry a label indicating that node's unit type. Whenever the output of that node is displayed, its line is displayed with a color corresponding to the unit type (e.g., dollar values may be displayed in green as shown in FIG. 6), so that a user may easily and quickly see which values are comparable to each other). Thus, in general, in one or more embodiments, different colors and/or textures may be assigned to different units, so that the meaning of each number and comparisons of like numbers are visually easy to determine.

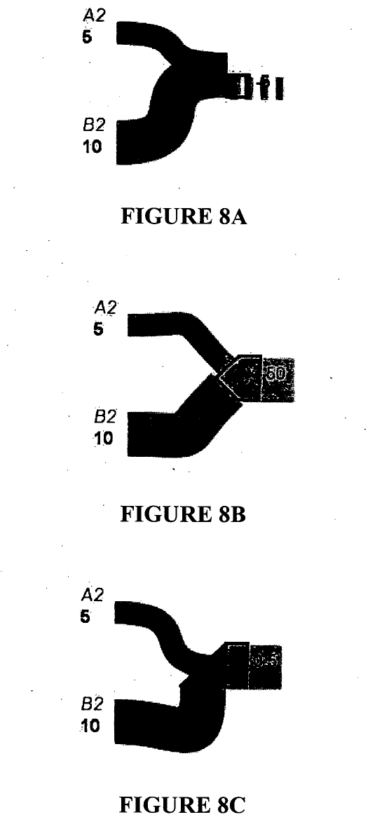

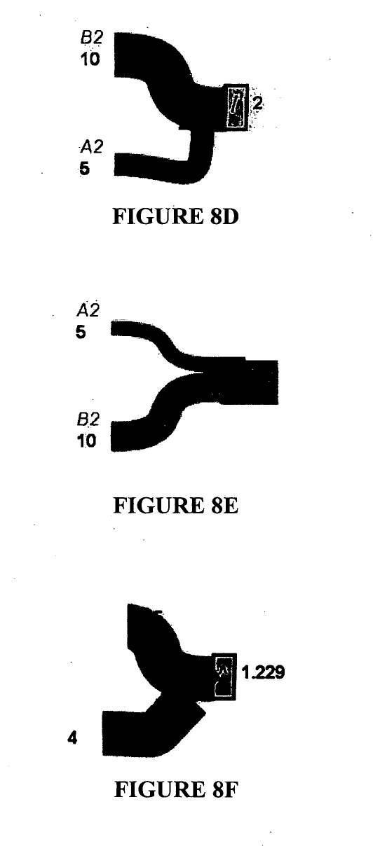

Further, in one or more embodiments, different colors and/or textures may be assigned to positive and negative numbers, so it is easy to visually distinguish between two values of the same magnitude and opposite sign and determine which visible values are positive and which are negative. For example, an output value “−5” may be shown by a striped line as shown in FIG. 8A. Moreover, those skilled in the art will note that, for example, using color for units and texture for positive/negative differentiation (or vice-versa) allows both units and sign to be distinguishable simultaneously and independently.

Each node's numeric output may be positive or negative, and it may be important that the display make such a distinction visually obvious when drawing the output of the node. For example, a drawing command may be invoked with alternate textures, such a solid lines for positive numbers and dashed ones for negative numbers. Or, for example, positive number may be displayed with lines of one color and negative numbers with lines of another color.

Unit Determination

In one or more embodiments, the numerical computation visualization tool 20 automatically determines which values in a formula share like units, either by extracting labels from a file and/or assigning like units to any numbers linked by certain unit-preserving computations (e.g., addition, subtraction, maximum/minimum, averaging, median). Thus, the numerical computation visualization tool 20 may automatically determine which numbers are to be labeled and normalized together, even if the author of the computations did not label those numbers.

In one or more embodiments, assigning a unit type to a number may be dependent on reading that cell's label from the spreadsheet. For example, all cells with a label are assigned unit type 1, all cells with “%” are assigned unit type 2, and so forth.

Further, assigning unit types to those cells and intermediate numbers that are not originally labeled may be based on a rule that all nodes sharing a parent, child, or sibling relation via a summation-like computation have the same unit type (summation-like computations are adding, subtracting, averaging, median, maximum, and minimum). Thus, it may be possible, given a single node with a known unit type, to traverse the tree structure from one node to its parents, children, and siblings (if the operation is summation-like) and assign those nodes the same unit type. Further, it may be possible to propagate the unit type to their children, parents, and siblings, until such relationships have been exhausted. Accordingly, a unit type may be propagated to other nodes linked to it by unit-preserving computations.

After one such group of related nodes has been assigned, the numerical computation visualization tool 20 may find a fresh node with no assignment, arbitrarily assign it a different unit type, and propagate that unit to all other related nodes in the manner described above . . . and so on, until all nodes in the tree structure are assigned units. Those skilled in the art will note that although such a mechanism does not guarantee the “correct” labeling (i.e., the one intended by the spreadsheet author), it does ensure that if any two units can be linked by unit-preserving computations, they share the same unit type.

Node Display

In one or more embodiments, the numerical computation visualization tool 20 visually distinguishes different computations by different shapes drawn at the locations of their nodes. The implementation uses the node's center location as a reference and then constructs a series of (x,y) points around the reference according to the node's computation (e.g., four points for a rectangle for summation, three points for a triangle for division). The location of these points may be determined by several factors: by the numerical value of the node's outputs (i.e., wide vs. narrow); by the node's axis (i.e., its tilt relative to horizontal), because node shapes are aligned with the direction of the output line, which may vary according to input and output locations; and by the relative positions of the node's inputs (e.g., numerator vs. denominator). That array of points is then passed to, for example, a graphing function, which creates a proper node shape aligned with its inputs and outputs.

Further, in one or more embodiments, the spreadsheet computation visualization tool 20 automatically arranges the way in which lines enter a computation node according to the computation. In other words, the numerical computation visualization tool 20 determines how input lines line up, what angles they subtend relative to each other, and/or how they overlap. For example, inputs to a subtraction node may be parallel and overlapping (so that their difference is evident visually as shown, for example, in FIG. 8A), inputs to a multiplication node may arrive at 90 degrees to one another (e.g., as shown in FIG. 8B), inputs to a division node may be represented like that shown, for example, in FIGS. 8C and 8D, inputs to a summation node may arrive in parallel side-by-side (so their widths sum visually as shown, for example, in FIG. 8E), and inputs to an exponent node may be represented like that shown, for example, in FIG. 8F.

At the time a node's display shape/size/orientation is calculated (described above), the implementation also calculates the position on the node's perimeter at which the input lines terminate, as well as their angle. For summation, for example as shown in FIG. 9, the input lines may be grouped into positive and negative groups (to make it easier to see what cancels what) and ordered within each group according to the position of their sources, so that lines do not have overlap in their paths from source to node. Then, each line in turn may be assigned a termination position on the rectangular node shape: the leftmost line has its far left edge on the left edge of the node box; the next line terminates right next to it (offset just enough to abut the first); the next one abutting that; and so forth. Each line may also be assigned an angle of termination, so that it terminates parallel to its neighbors and to the node's own axis.

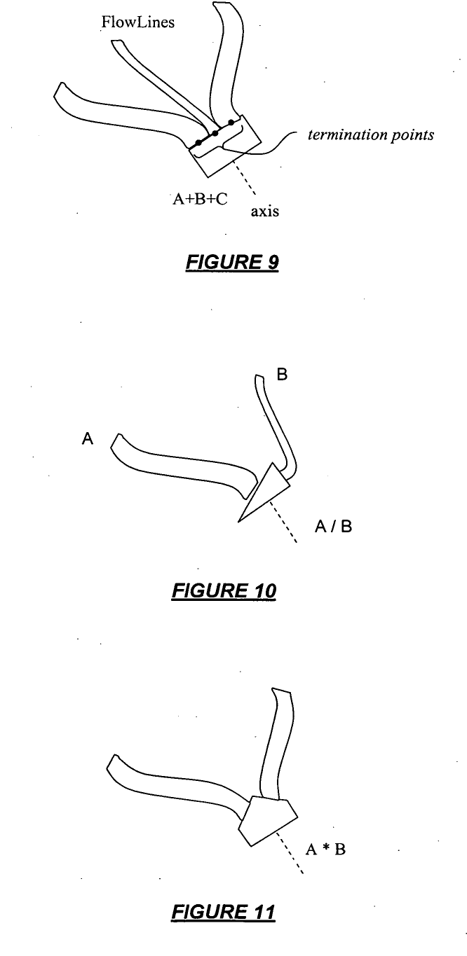

For a division node, for example as shown in FIGS. 8d, 8e, and 10, the numerator line arrives parallel to the axis of the node, but the denominator line arrives perpendicular to the axis (each one terminating on the midpoint of the respective side of the triangle).

For a multiplication node with two inputs, for example as shown in FIGS. 8b and 11, each input terminates perpendicular to an upper face of the pentagonal node-shape, at the face's midpoint.

Those skilled in the art will note that the node shapes described above are just examples. Different shapes may be chosen, but similar computations may still be necessary to align input and output lines with their corresponding facets on the shape.

Superimposing

In one or more embodiments, the numerical computation visualization tool 20 automatically superimposes the display of a computation on top of a visual representation of its source, such as the grid of a spreadsheet, visually linking each computation input and result to the spreadsheet cell it represents. In one example, such an implementation first draws a faint grey grid representing the spreadsheet, with the clickable “=” icons on cells with formulas. The coordinates of each cell are recorded and referenced by the corresponding parts of the software object, so a line or node shape may be displayed on the corresponding cell.

Automatic Labeling

In one or more embodiments, the numerical computation visualization tool 20 automatically labels the inputs and outputs to nodes by their values (e.g., printing “5” next to a line whose value represents the number 5). A line may show its value not only by its own visual properties (e.g., width (magnitude), color (unit type), texture (sign)), but also by having the text-string representation printed next to it (e.g., “−$5”). Those skilled in the art will note that such a mechanism is straightforward because the corresponding node in the software object stores all those attributes, so that the same subroutines or methods which display the node shape may also display the string value graphically.

Node Arrangement

In one or more embodiments, the numerical computation visualization tool 20 automatically arranges the position of nodes on the page according to the relative positions of the nodes' inputs and outputs on the spreadsheet, to minimize the overlapping of the nodes and lines connecting them, and to cleanly separate the nodes visually. On a typical spreadsheet, computation proceeds left-to-right, with the raw inputs in cells toward the left and the derived or computed results appearing in cells toward the right. For such a spreadsheet, the displayed computation lines flow from the upper left (raw inputs) to the lower right (output result), with various nodes interconnected by lines filling the space in between. While there are many ways of arranging the positions of the nodes and lines without overlapping or tangling, one example is shown in FIG. 7.

At this point, every vertical and horizontal position of every node in the tree has been assigned, as a first approximation. However, because those positions have been calculated independently of each other, it is possible that two of those nodes are nearly overlapping, and thus hard to visually distinguish. To avoid such an outcome, the vertical and horizontal positions of all the nodes may be adjusted to “attract” or “repel” each other, so that overlapping nodes are pushed apart (by, for example, moving each one a short distance away from each other). Likewise, parent nodes and their children may be “attracted” to each other to ensure that the lines connecting them are not stretched any longer than necessary. Such incremental pushing and pulling of neighboring nodes, when iterated several times, may rearrange the nodes to produce a visually pleasing layout.

Those skilled in the art will note that principles described above may also be applied to computations arranged vertically (like the columns of a sum) by switching the roles of horizontal and vertical coordinates in the description above.

In one or more other embodiments, each computation node may be anchored on its cell in the spreadsheet grid, and the lines lie on top of the grid itself. In this case, the horizontal and vertical locations of the nodes may be chosen to be the same as those computed for their cells in the grid.

Simplification

In one or more embodiments, the numerical computation visualization tool 20 modifies an image of a spreadsheet and lines to reduce visual confusion. When lines and computation nodes are superimposed on an image of the spreadsheet grid, there may be visual clutter of the many numbers, grid-lines, and lines to distract the eye and make comprehension difficult. One technique for reducing such visual confusion is to display the spreadsheet grid (and its associated numbers) in a light color (like light grey), just dark enough to serve as a frame of reference but light enough to be visually distinct from the more clearly-defined and colored visualization elements. In one or more other embodiments, it is ensured that all input lines are curved, as curves are visually easy to distinguish from the straight lines of a spreadsheet grid. Curves have the further advantage that the curves linking a set of inputs to a computation will not overlap, even if all the inputs lie on the same line as the computation result.

Display of Dependent Cells

In one or more embodiments, the numerical computation visualization tool 20 displays the dependent cells of a computation. There are two approaches to visualizing a computation: to see the various inputs to a cell, and to see its outputs. Connections to other cells that make use of a given cell, its “dependents”, may be displayed with lines also. In the example shown in FIG. 1, the fat red curve shows that the result in cell A8 is used in cell C8.

In the exemplar embodiment shown in FIG. 1, selecting a cell shows both the inputs to its computation and all its outputs to other cells. Note that some cells may have outputs to other cells but no inputs, i.e. if the cell is a pure number without a formula, and some may have inputs (a formula) but no dependent outputs. In FIG. 1, those features are shown independently: a “=” sign in a cell represents a formula; and right-pointing arrows (“>>>”) in the corner represent outputs, so that the cells at B3-B6 have a single output (“>”) but no formula, the cells in column C have formulas but no output, and the cell at B8 has a formula and several outputs.

The mechanism for discovering the outputs of a given cell is subjectively subtle, given that the formulas contained in a spreadsheet file refer only to the cell's inputs and not to its outputs. However, the output/dependent relation may be recorded when parsing the formula: whenever an input cell is encountered in the formula, a label may be attached to that input cell, giving the identity of its parent. At the end of parsing, each cell may then have accumulated two groups of nodes: those it depends on (the precedents) and those that depend on it (the dependents). The list of dependents may be used for displaying outputs as described here and for discovering all nodes linked to this node by sum-like operations, as described in above.

Separate Visualizations

In one or more embodiments, the numerical computation visualization tool 20 may display the selectable visualization of the spreadsheet separately from the original spreadsheet. It is easiest to visualize a spreadsheet's computations when they look like the spreadsheet itself, i.e., as a grid of numbers in their original locations, but there may be disadvantages to creating the visualization as part of the original spreadsheet itself. First, the user's actions (e.g., clicks, mouse-drags, typing) involved in the visualization may create changes in the spreadsheet itself (because the spreadsheet is also an active document), possibly modifying the data in ways the user may not want. Second, spreadsheets are typically displayed as high-contrast grids with high-contrast numbers, features which are very useful when editing their data but may distract from the very different visualization features of a spreadsheet displayed in accordance with one or more embodiments. Third, it is useful in a spreadsheet in accordance with one or more embodiments to display other information in addition to that contained in a typical spreadsheet cell, e.g., the presence of a formula (e.g., “=” symbol), the number of output/dependent cells, the open/closed state of the cell (e.g., “+”, “−”), and grid-coordinates (e.g., “A8”). As a result, it may be advantageous to construct a spreadsheet in accordance with one or more embodiments as a separate visualization grid, looking approximately like the original spreadsheet but with extra information, different coloration, and a different response to user commands (e.g., clicks, mouse-drags, typing).

Those skilled in the art will note that implementing a free-standing visualization may be easier than integrating the visualization into a typical spreadsheet program (e.g., Microsoft Excel®). Once the original spreadsheet file has been read and parsed as described above, that information can be passed to a standalone program (e.g., a Java-language executable or Applet), which “paints” the visualization from scratch: it draws a rectangle in the place of each cell; draws strings representing numerical quantities inside those rectangles; draws computation nodes and lines between open nodes; determines which cell is selected by comparing the selection coordinates to those of the cells it drew. Such a scheme allows control over the color and transparency of drawn features, so, for example, lines may be drawn semi-transparent in order to show details of how they cross and overlap.

Flattened Visualization

FIG. 7 shows an example of spreadsheet visualization computation in accordance with an embodiment of the present invention. In FIG. 7, the inputs are the numbers at left, and computations occur moving toward the right, wherever inputs arrive together. Moreover, the computations are not superimposed on the spreadsheet from which they are created. Inputs may be spaced evenly apart and ordered to minimize overlap, and computations are created from successive combinations of inputs and indented rightwards, regardless of the locations of the original inputs or computations on the spreadsheet grid. This approach seeks to clarify the structure of the computation at the possible expense of locating the inputs on the spreadsheet grid and may be available as a simultaneous alternative to the grid-based visualizations described above. However, other arrangements are possible in one or more other embodiments. For example, computations may occur from top to bottom (or diagonally), lines may curved, and/or other textures and colors may be used.

While the invention has been described with respect to a limited number of embodiments, those skilled in the art, having benefit of the above description, will appreciate that other embodiments may be devised which do not depart from the scope of the present invention as described herein. Accordingly, the scope of the present invention should be limited only by the appended claims.

What is claimed is:

1. A computer-implemented method of visualizing numerical computations, comprising:
inputting an information source specifying numbers and computations using the numbers;
extracting information from the inputted information source;
constructing a software object with representations of computations associated with the extracted information; and
displaying at least one of the computations, wherein the at least one displayed computation includes a node having at least one input line.

2. The computer-implemented method of claim 1, wherein the at least one input line is displayed as one of a straight line and a curved line.

3. The computer-implemented method of claim 1, wherein at least a portion of the at least one input line is one of semi-transparent and transparent.

4. The computer-implemented method of claim 1, wherein the information source is a spreadsheet file.

5. The computer-implemented method of claim 1, wherein the information source is in at least one of a programming language, a scripting language, a business-logic program, data-analysis software, and a native database language.

6. The computer-implemented method of claim 1, further comprising:
determining like units of numbers in the at least one computation.

7. The computer-implemented method of claim 1, wherein the displaying comprises:
flattening the display of the at least one computation.

8. The computer-implemented method of claim 1, wherein the displaying comprises:
automatically labeling a value of the node in the display of the at least one computation.

9. The computer-implemented method of claim 8, wherein the at least one computation is a multi-step computation, and wherein the node represents an intermediate step in the multi-step computation.

10. The computer-implemented method of claim 1, wherein the displaying comprises:
visually rendering at least a portion of the information source; and
visually de-emphasizing at least a portion of the rendered information source in order to emphasize the display of the at least one computation.

11. The computer-implemented method of claim 1, wherein the display of the at least one computation comprises a symbol to indicate that a cell in the information source contains one of a formula and an output.

12. The computer-implemented method of claim 1, further comprising:
assigning at least one of a color and a texture to the at least one input line dependent on a unit type of the at least one input line.

13. The computer-implemented method of claim 1, further comprising:
assigning at least one of a color and a texture to the at least one input line dependent on a sign of a number represented by the at least one input line.

14. The computer-implemented method of claim 1, further comprising:
determining a width of the at least one input line dependent on a magnitude of a number represented by the at least one input line.

15. The computer-implemented method of claim 1, wherein the node has another input line, and wherein a width of the at least one input line relative to a width of the another input line is dependent on a magnitude of the at least one input line relative to a magnitude of the another input line.

16. The computer-implemented method of claim 1, wherein a shape of the node is dependent on a type of computation represented by the node.

17. The computer-implemented method of claim 1, wherein display of the at least one computation is selectable.

18. The computer-implemented method of claim 1, wherein the software object is of a tree structure.

19. The computer-implemented method of claim 1, wherein the at least one displayed computation is displayed on top of a representation of the information source.

20. The computer-implemented method of claim 1, further comprising:
determining an orientation of the at least one input line with respect to at least one of a position and shape of the node.

21. The computer-implemented method of claim 1, wherein the node has an output line having a display dependent on a value represented by the at least one input line and a computation type represented by the node.

22. The computer-implemented method of claim 1, wherein the node has an output line having at least one of a color and a texture dependent on at least one of a magnitude of a value represented by the output line, a sign of the value, and a unit type of at least one of the value and the node.

23. A system for visualizing numerical computations, comprising:
a first module arranged to input data from an information source;
a second module arranged to parse the inputted data;
a third module arranged to construct a software object with information extracted by the second module; and
a fourth module arranged to display at least one computation represented by at least a portion of the extracted information in the software object, wherein the at least one displayed computation includes a node representing a computation using a value represented by at least one input line to the node.

24. The system of claim 23, wherein at least a portion of the at least one input line is one of semi-transparent and transparent.

25. The system of claim 23, wherein the fourth module is further arranged to determine like units of numbers in the at least one computation.

26. The system of claim 23, wherein the fourth module is further arranged to flatten the display of the at least one computation.

27. The system of claim 23, wherein the fourth module is further arranged to automatically label a value of the node in the display of the at least one computation.

28. The system of claim 23, wherein the at least one computation is a multi-step computation, and wherein the node represents an intermediate step in the multi-step computation.

29. The system of claim 23, wherein the fourth module is further arranged to visually render at least a portion of the information source.

30. The system of claim 29, wherein the fourth module is further arranged to visually de-emphasize at least a portion of the rendered information source in order to emphasize the display of the at least one computation.

31. The system of claim 23, wherein the display of the at least one computation comprises a symbol to indicate that a cell in the information source contains one of a formula and an output.

32. The system of claim 23, wherein the at least one input line is displayed as one of a straight line and a curved line.

33. The system of claim 23, wherein the at least one input line has at least one of a color and a texture dependent on a unit type of the at least one input line.

34. The system of claim 23, wherein the at least one input line has at least one of a color and a texture dependent on a sign of a number represented by the at least one input line.

35. The system of claim 23, wherein a width of the at least one input line is dependent on a magnitude of a number represented by the at least one input line.

36. The system of claim 23, wherein the node has another input line, and wherein a width of the at least one input line relative to a width of the another input line is dependent on a magnitude of the at least one input line relative to a magnitude of the another input line.

37. The system of claim 23, wherein a shape of the node is dependent on a type of computation represented by the node.

38. The system of claim 23, wherein display of the at least one displayed computation is selectable.

39. The system of claim 23, wherein the software object is of a tree structure.

40. The system of claim 23, wherein the at least one displayed computation is displayed on top of a representation of the information source.

41. The system of claim 23, wherein the fourth module is further arranged to determine an orientation of the at least one input line with respect to at least one of a position and shape of the node.

42. The system of claim 23, wherein the node has an output line having a display dependent on a value represented by the at least one input line and a computation type represented by the node.

43. The system of claim 23, wherein the node has an output line having at least one of a color and a texture dependent on at least one of a magnitude of a value represented by the output line, a sign of the value, and a unit type of at least one of the value and the node.

44. The system of claim 23, wherein the information source is a spreadsheet file.

45. The system of claim 23, wherein the information source is in at least one of a programming language, a scripting language, a business-logic program, data-analysis software, and a native database language.

50. A computer-readable medium having instructions stored therein and that are executable by a processor, the instructions comprising instructions to:
read in an information source;
extract information from the read information source;
construct a software object with representations of computations associated with the extracted information; and
display at least one of the computations, wherein the at least one displayed computation includes a node having at least one input line.

51. The computer-readable medium of claim 50, wherein at least a portion of the at least one input line is one of semi-transparent and transparent.

52. The computer-readable medium of claim 50, further comprising instructions to:
determine like units of numbers in the at least one computation.

53. The computer-readable medium of claim 50, further comprising instructions to:
flatten the display of the at least one computation.

54. The computer-readable medium of claim 50, further comprising instructions to:
automatically label a value of the node in the display of the at least one computation.

55. The computer-readable medium of claim 50, wherein the at least one computation is a multi-step computation, and wherein the node represents an intermediate step in the multi-step computation.

56. The computer-readable medium of claim 50, further comprising instructions to:
visually render at least a portion of the information source; and
visually de-emphasize at least a portion of the rendered information source in order to emphasize the display of the at least one computation.

57. The computer-readable medium of claim 50, wherein the display of the at least one computation comprises a symbol to indicate that a cell in the information source contains one of a formula and an output.

58. The computer-readable medium of claim 50, wherein the at least one input line is displayed as one of a straight line and a curved line.

59. The computer-readable medium of claim 50, further comprising instructions to:
assign at least one of a color and a texture to the at least one input line dependent on a unit type of the at least one input line.

60. The computer-readable medium of claim 50, further comprising instructions to:
assign at least one of a color and a texture to the at least one input line dependent on a sign of a number represented by the at least one input line.

61. The computer-readable medium of claim 50, further comprising instructions to:
determine a width of the at least one input line dependent on a magnitude of a number represented by the at least one input line.

62. The computer-readable medium of claim 50, wherein the node has another input line, and wherein a width of the at least one input line relative to a width of the another input line is dependent on a magnitude of the at least one input line relative to a magnitude of the another input line.

63. The computer-readable medium of claim 50, wherein a shape of the node is dependent on a type of computation represented by the node.

64. The computer-readable medium of claim 50, wherein display of the at least one displayed computation is selectable.

65. The computer-readable medium of claim 50, wherein the software object is of a tree structure.

66. The computer-readable medium of claim 50, wherein the at least one displayed computation is displayed on top of a representation of the information source.

67. The computer-readable medium of claim 50, further comprising instructions to:
determine an orientation of the at least one input line with respect to at least one of a position and shape of the node.

68. The computer-readable medium of claim 50, wherein the node has an output line having a display dependent on a value represented by the at least one input line and a computation type represented by the node.

69. The computer-readable medium of claim 50, wherein the node has an output line having at least one of a color and a texture dependent on at least one of a magnitude of a value represented by the output line, a sign of the value, and a unit type of at least one of the value and the node.

70. The computer-readable medium of claim 50, wherein the information source is a spreadsheet file.

71. The computer-readable medium of claim 50, wherein the information source is in at least one of a programming language, a scripting language, a business-logic program, data-analysis software, and a native database language.
